(19) United States
(12) Patent Application Publication
(10) Pub. No.: US 2001/0020232 A1
(43) Pub. Date: Sep. 6, 2001

(54) Method and apparatus for handling prize advertisement on communication network

(76) Inventor: Hironori Yasuda, Saitama (JP)

Correspondence Address: VENABLE, Post Office Box 34385, Washington, DC, 20043-9998, US

(21) Appl. No.: 09/771,560

(22) Filed: Jan. 30, 2001

(30) Foreign Application Priority Data
Mar. 1, 2000 (JP) 056092/2000

(51) Int. Cl. G06F 17/60

(52) U.S. Cl. 705/14

(57) ABSTRACT

According to the present invention, in a method and an apparatus for handling a prize advertisement through a communication network, (in a system), a prize advertisement request is received through the communication network and the received prize advertisement is classified in accordance with prize contents and stored. The stored prize advertisement is distributed together with a display form instruction corresponding to the classification to a visitor through the communication network. An entry for the distributed prize advertisement is received together with additional information regarding an entrant via the communication network. Further, the number of entries for the prize advertisement is accumulated together with the additional information of the entrants to form an accumulation report. The accumulation report is transmitted to a client through the communication network.

### BACKGROUND OF THE INVENTION

The present invention relates to a method and an apparatus for handling a prize advertisement, and more particularly, to a method and an apparatus for handling a prize advertisement via a communication network.

Heretofore, each of companies has independently carried out this kind of advertisement on its house site. The user accesses the site of the company, fills out a questionnaire and inputs personal information, and after that, enters a prize. There is also a site where links to the companies are collected, classified in accordance with genres of prizes, and presented. The user accesses those sites, finds out a prize site he desires, and then accesses an advertisement questionnaire site with a prize of the company. From the viewpoint of the user's convenience, there is also a site to provide a prize entry acting service. The user previously registers personal information on the site and pays a commission corresponding to an entry period and the number of entries, so that he can allow the site to act the entry a prize site.

However, even in any above-mentioned method, each company finally performs troublesome works such as independently forming an advertisement questionnaire collecting system (which is linked with a database) on the house site, accumulating data obtained by the above system by an accumulating system, and forming a report. From the viewpoint of the convenience of the user, the user easily finds out an item he desires by using the prize link site but he must input personal information such as his address and name on each prize site each time. The extremely troublesome operations are needed. As for the prize entry acting service, from the viewpoint of the convenience of the user, it is very convenient. However, from the viewpoint of the company which intends to advertise and collect advertisement questionnaires, the advertising action is substantially purposeless, and such a service is not preferable.

### SUMMARY OF THE INVENTION

It is an object of the invention to provide method and apparatus for handling a prize advertisement on a communication network, which intend to suit the conveniences of both of the users and companies.

According to the present invention, there are provided method and apparatus for handling a prize advertisement through a communication network, wherein (in a system) a prize advertisement request is received through the communication network; the received prize advertisement is classified in accordance with prize contents and stored; the stored prize advertisement is distributed together with a display form instruction corresponding to the classification to a visitor through the communication network; an entry for the distributed prize advertisement is received together with additional information regarding an entrant via the communication network; the number of entries for the prize advertisement is further accumulated together with the additional information of the entrants to form an accumulation report; and the accumulation report is transmitted to the client through the communication network.

### BRIEF DESCRIPTION OF THE DRAWINGS

FIG. 1 is a diagram showing the construction of an apparatus for handling a prize advertisement;

FIG. 2 is a flowchart showing a method of handling a prize advertisement;

FIG. 3 is a flowchart showing the detail of an entry receiving process in FIG. 2;

FIG. 4 is a flowchart showing the detail of a process of forming an accumulation report in FIG. 2;

FIGS. 5A to 5C are diagrams showing display examples of Web pages;

FIG. 6 is a flowchart showing a process of announcing a prizewinner; and

FIG. 7 is a diagram showing the link constructional example of a Web page.

### DETAILED DESCRIPTION OF THE PREFERRED EMBODIMENT

An embodiment of the present invention will now be described hereinbelow with reference to the drawings.

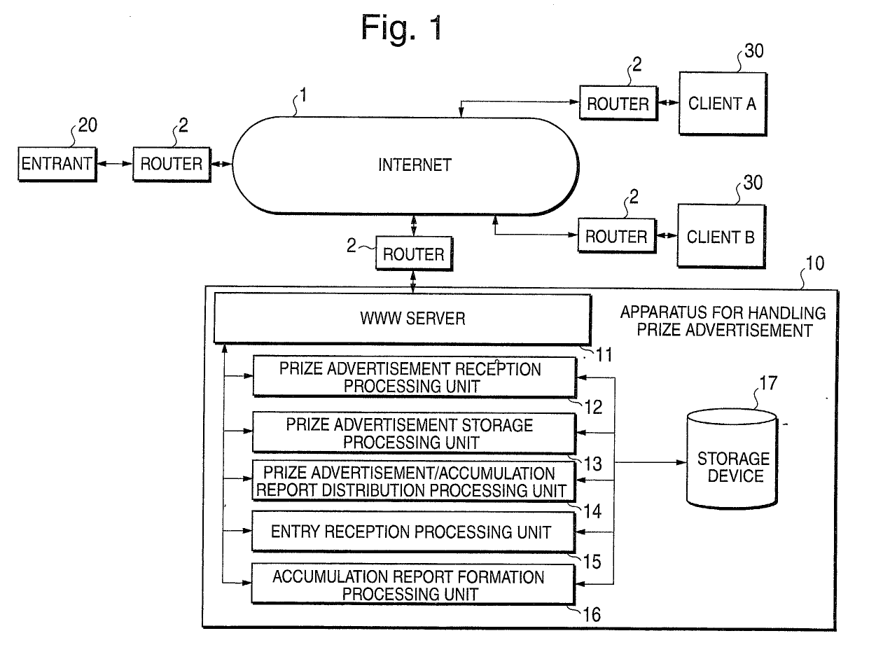

FIG. 1 shows an embodiment of an apparatus for handling a prize advertisement. A main apparatus 10 is always connected to a communication network such as the Internet by, for example, a public or private telephone line through an Internet provider. The apparatus 10 has a unique URL (Uniform Resource Locator), namely, an IP address. Visitors (namely, site users on the Internet) through the Internet, including entrants and clients, can access the Web page by designating the IP address. As a hardware construction, the apparatus 10 is comprised of a normal computer device comprising a storage device 17, and further comprising a central processing unit, a memory, a keyboard, a mouse, and a display. It is connected to the communication network via a router 2. As a software construction of the apparatus 10, it contains a control program that can be connected to the Internet. Under the control, a WWW server 11 operates as a continuous process. In response to viewing requests of the visitors including the clients and entrants, the server distributes Web pages stored in the storage device 17 simultaneously in parallel with the requests. In response to a reply message from the entrant, the WWW server 11 allows a corresponding processing section to be executed. The processing section is a technique known as a CGI (Common Gateway Interface) which can be formed by a script language such as a Perl language. The processing section includes a prize advertisement reception processing unit 12, an entrant reception processing unit 15, and an accumulation report formation processing unit 16. The plurality of processing units receive various instructions including the reply message of the visitor from the WWW server 11 and store necessary data to the storage device 17 in response to the instructions.

When a normal personal computer having, for example, a Web browser (Web page viewing program) is connected to the public telephone line by the router 2 (or a modem), the entrant or client can communicate with the Internet via an Internet provider (not shown) by using the computer. The entrant or client may connect to the Internet as necessary. The IP address is allocated every Internet connection by the Internet provider. Since the apparatus 10 distributes the Web page in response to the Web page viewing request from the entrant or client, it can transmit it so as to reply to the IP address of the viewing request source. It is unnecessary to regularly know the IP address of the entrant or client.

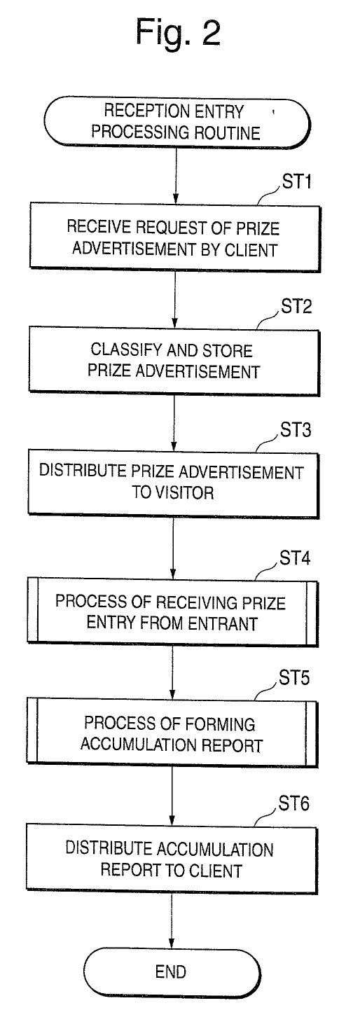

FIG. 2 shows a reception entry processing routine which the WWW server 11 and the processing unit 12 or 16 of the above-mentioned apparatus 10 cooperatively execute. In other words, the processing routine handles a prize advertisement between the client who requests an advertisement and the visitor who enters the prize advertisement through the Internet as a communication network.

In the routine, the prize advertisement reception processing unit 12 is first used and waits for a request from an advertisement client. When a request is generated, the unit receives and accepts a Web page including contents of the prize advertisement (ST1). In this instance, it may request a client ID and a password for a process of authenticating the advertisement client, which will be executed later. Subsequently, a prize advertisement storage processing unit 13 is used to classify the Web page in accordance with prize contents such as kind of prize or method of paying a reward and then store it (ST2). Subsequently, a prize advertisement/accumulation report distribution processing unit 14 is used. When the viewing request of the visitor is generated, the unit distributes the Web page together with its display form instruction to the visitor so that he can view it (ST3). The display form instruction is used as a code to instruct a terminal on the distribution destination side to display a plurality of advertisements so as to be made to correspond to the list of prize contents. Subsequently, the entrant reception processing unit 15 is used, waits for a reply message indicative of an entry from the visitor, who viewed the Web page, namely, an entrant, and receives it (ST4) . A plurality of replay messages by the entered visitors, namely, entrants are collected. Subsequently, the accumulation report formation processing unit 16 is used. After an available period of the prize advertisement, the unit performs the accumulation regarding the prize advertisement to form an accumulation report (ST5). Subsequently, the prize advertisement/accumulation report distribution processing unit 14 is used to distribute the accumulation report to the client (ST6).

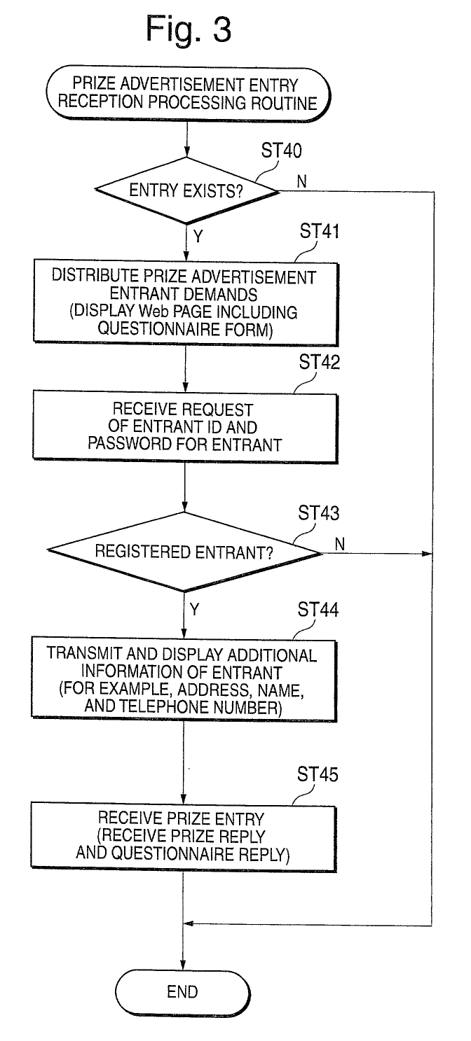

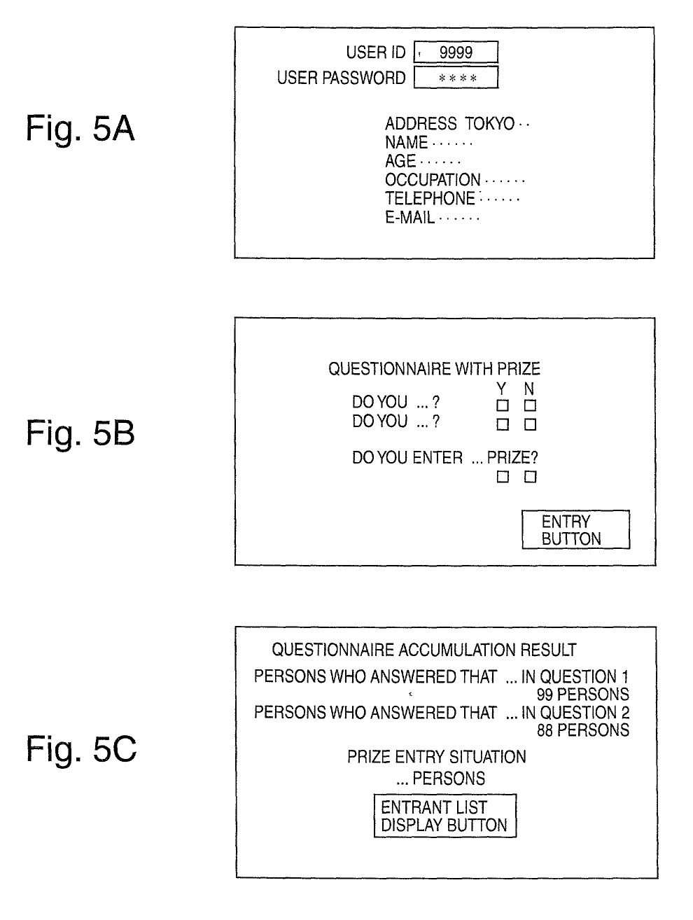

FIG. 3 shows a detail routine in the entry receiving step ST4 in the routine shown in FIG. 2. In the example, the prize advertisement includes a questionnaire together with the prize. First, when there is an entry from among the visitors (ST40), the Web page of the prize advertisement with the questionnaire which the entrant demands (ST41). Subsequently, an authenticating process indicative of whether the entrant is a registered entrant or not is performed (ST42). When he is an unregistered entrant, his personal information is individually inputted. Alternatively, it is possible to inhibit the unregistered entrant from answering the questionnaire and/or entering the prize (ST43) When the registered entrant inputs the entrant ID and entrant password alone on the Web page, additional information of the entrant is searched and read out from the storage device 17 and then displayed on the Web page so as to fill out (ST44). The display example of this case is shown in FIG. 5A. In this instance, the entrant confirms the display or partially changes and inputs additional information through the Web page screen as necessary without inputting all of the additional information of the entrant, and he can send the questionnaire or prize entry including the additional information of the entrant as a reply message. Accordingly, the questionnaire or prize entry from the entrant can be easily performed. The additional information of the entrant preferably includes personal information such as address, name, age, occupation, telephone number, and E-mail address. There is also considered such a service for the client that whether the entrant demands to receive a new advertisement via E-mail or not is confirmed to the entrant alone and, when he demands it, appearing the new advertisement is notified to the entrant through the E-mail.

FIG. 5B shows a display example on a terminal screen in the case of the prize advertisement with a questionnaire. The entrant depresses a transmission button (entry button) in the Web page on the terminal screen (for example, a click by a mouse). Consequently, the reply message on the whole Web page is sent to the apparatus 10. The apparatus 10 receives it (ST45). The received reply message is stored to the storage device 17.

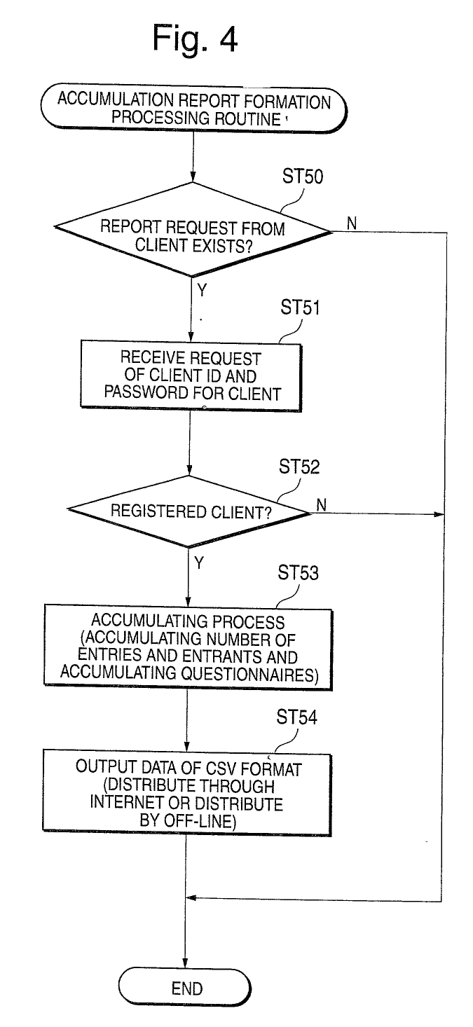

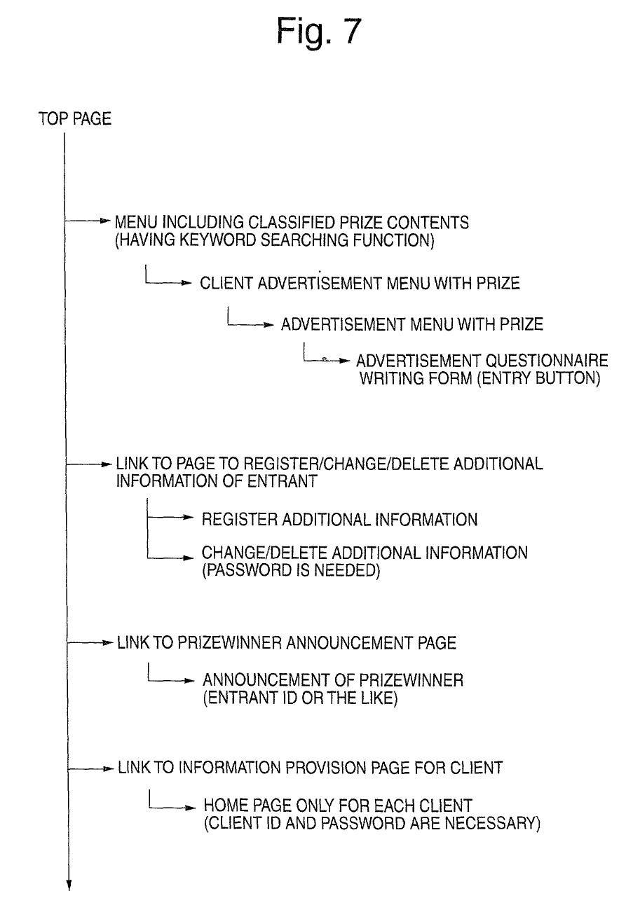

FIG. 4 shows the accumulation report forming process in the routine in FIG. 2 in more detail. When the client views the accumulation report, the client first sends a client password to perform the authenticating process (ST51). When he is not confirmed as a registered client by the authenticating process, viewing the accumulation report is inhibited (ST52) . Accordingly, the security protection of the contents of the accumulation report is realized. Subsequently, when the client, who obtained the authentication by the authenticating process, designates the original Web page and specifies the accumulation report which he demands, the accumulation report is edited as a Web page and then distributed (ST53). A display example in this case is shown in FIG. 5C. Since the questionnaire accumulation report is provided on the Web page (HTML document format) through the Internet, he can view the report anytime everywhere so long as he can use the Web browser. Since the report is provided in a real-time manner, the client can promptly utilize it for an advertisement strategy or article strategy. The exclusive-use Web page (refer to FIG. 7) for lo the client to which the questionnaire accumulation report is submitted is managed on the basis of the client ID and password, so that the security protection can be accomplished.

The accumulation result can be converted into a CSV format (Comma Separated Value), namely, a format that can be read by normal spreadsheet software (for example, EXCEL (registered trademark) of Microsoft Corp. or 1-2-3 (registered trademark) of Lotus Corp.) (ST54). Consequently, the client can independently analyze it.

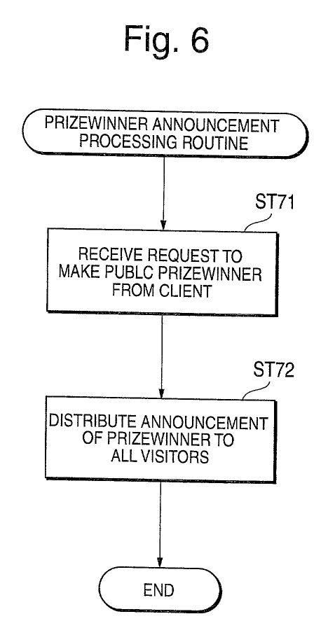

Finally, as for the announcement of the prizewinner, as shown in a flowchart of FIG. 6, the determination of the prizewinner by the client is received (ST71) and it is sent as a Web page (ST72). The announcement of the prize winning result is more apparent than a method of notifying the prizewinner alone by sending a prize, so that the visitor's will to enter the prize is heightened. The prize winning result is announced by using not personal information such as name of the prizewinner but the entrant ID number, so that the privacy of the prizewinner can be protected.

FIG. 7 shows the constructional example of the Web page when the above-described method is executed. The visitor including the entrant through the, Internet can enter the site by designating the URL of the top page. Further, the top page has links to a menu including classified prize contents, a personal information register page, a prizewinner announcement page, and an information provision page for the client. It is possible to easily shift to each of the pages 10 by the Web browser. Since the advertisement site with the prize easily attracts the Internet users, advertising and executing a questionnaire can be efficiently performed to more users. Medium-sized and smaller companies having no house site can also positively perform a marketing action by using the present site.

Since the menu including classified prize contents is presented, the visitor can easily find out a prize page he demands by using a keyword searching function. Hitherto, when the entrant enters the prize on a prize site presented by an advertisement client such as a company, he must input personal information such as his address and name each time. Differently from the above, since the personal information register page is provided, the entrant uses the present page and the troublesome operations are not needed. In addition to the entrant ID number, an entry by an E-mail address is permitted, so that it is unnecessary to remember the entrant ID number shown by alphanumerical characters of several digits. Since the authentication on the basis of the password is performed at the time of changing or deleting personal information, the entrant himself can manage his personal information which requires security protection. Since the information provision page for the client is provided, differently from that each client performs the operations on its house site, troublesome works such as accumulation of advertisement questionnaires and formation of the report can be performed by viewing the present page.

What is claimed is:

1. A method of handling a prize advertisement through a communication network, comprising:
a receiving step of receiving a prize advertisement request via the communication network;
a storing step of classifying said received prize advertisement in accordance with prize contents and storing;
a distributing step of distributing the stored prize advertisement together with a display form instruction corresponding to the classification to a visitor through the communication network;
an entry receiving step of receiving an entry for the distributed prize advertisement together with additional information regarding an entrant through the network;
an accumulating step of accumulating the number of entries for the prize advertisement together with the additional information of the entrants to form an accumulation report; and
a step of transmitting said accumulation report to a client through the network.

2. The method according to claim 1, wherein said additional information includes identifying character information with respect to the whole entrant or an E-mail address which said entrant subscribes.

3. The method according to claim 1 or 2, further comprising a step of receiving through the communication network a request for announcing a prizewinner by the client who subscribed for the prize advertisement and transmitting it to said visitor via the communication network.

4. An apparatus for handling a prize advertisement through a communication network, comprising:
receiving means for receiving a prize advertisement request through said communication network;
storing means for classifying said received prize advertisement in accordance with prize contents and storing;
distributing means for distributing the stored prize advertisement together with a display form instruction corresponding to the classification to a visitor through the communication network;
entry receiving means for receiving an entry for the distributed prize advertisement together with additional information regarding an entrant through the network;
accumulating means for accumulating the number of entries for the prize advertisement together with the additional information of the entrants to form an accumulation report; and
means for transmitting said accumulation report to a client through the network.

5. The apparatus according to claim 4, wherein said additional information includes identifying character information with respect to all of the entrants or E-mail addresses which said entrant subscribes.

6. The apparatus according to claim 4 or 5, further comprising means for receiving through the communication network a request for announcing a prizewinner by the client who subscribed for the prize advertisement and transmitting it to said visitor via the communication network.
